(19) United States
(12) Patent Application Publication
(10) Pub. No.: US 2022/0237095 A1
(43) Pub. Date: Jul. 28, 2022

(54) LOG RETRIEVAL SUPPORT DEVICE AND LOG RETRIEVAL SUPPORT METHOD

(71) Applicant: HITACHI, LTD., Tokyo (JP)

(72) Inventors: Yasunari Takai, Tokyo (JP); Tadahisa Kato, Tokyo (JP); Yuki Noyori, Tokyo (JP); Michio Iijima, Tokyo (JP); Yoshikatsu Saitou, Tokyo (JP)

(73) Assignee: HITACHI, LTD., Tokyo (JP)

(21) Appl. No.: 17/468,591

(22) Filed: Sep. 7, 2021

(30) Foreign Application Priority Data
Jan. 28, 2021 (JP) 2021-011852

(51) Int. Cl. G06F 11/30; G06F 11/07

(52) U.S. Cl. CPC G06F 11/3072; G06F 11/0781

(57) ABSTRACT

A log retrieval support device 30 specifies a rare series that is an abnormal event group in a log recording a plurality of events executed in a predetermined system, generates a condition for regarding that there is a log having the same event group as each of the rare series, and specifies the number or ratio of logs having the same event group as each of the rare series among a plurality of logs recording a plurality of events executed in the predetermined system on the basis of the conditions. The log retrieval support device generates a new condition obtained by partially relaxing the condition in the case where the number or ratio is less than a predetermined value and generates a new condition obtained by partially limiting the condition in the case where the number or ratio is the predetermined value or more.

### CROSS-REFERENCE TO RELATED APPLICATIONS

This application claims priority pursuant to Japanese patent application No. 2021-011852, filed on Jan. 28, 2021, the entire disclosure of which is incorporated herein by reference.

### BACKGROUND

### Technical Field

The present disclosure relates to a log retrieval support device and a log retrieval support method.

### Related Art

In the case where an abnormality occurs in a system, a system administrator analyzes an event log output by the system and specifies an event causing the abnormality to try to resolve the failure and prevent the occurrence in the future.

As a technique for analyzing an event log, WO2015/178000 discloses that an unknown pattern to be evaluated and a known pattern are compared with each other in similarity, and in this case, as the similarity between the known pattern and the unknown pattern, an editing distance calculated by using a predetermined weight function is used, and if the editing distance is within a predetermined value, it is determined to be abnormal.

In addition, Japanese Unexamined Patent Application Publication No. 2015-141459 describes that an abnormal behavior detection device calculates a rare partial series (rare behavior partial series) appearing in a series from a set (event log) of behavior series of an operation subject, extracts a set of behavior series including the rare behavior partial series from the set of behavior series, obtains common partial series from the extracted set, and outputs a behavior appearing before the rare behavior partial series among the common partial series by regarding it as a cause of occurrence of the rare behavior partial series. In this case, it has been disclosed to detect a rare series using algorithms such as a Markov model, a k-means method, and a normal distribution.

### SUMMARY

However, in WO2015/178000, there is a case where an abnormality cannot be determined depending on the setting of the weight function or the predetermined value, and for example, even if there is an abnormality, it is determined that there is no abnormality.

In addition, also in Japanese Unexamined Patent Application Publication No. 2015-141459, there is a case where an abnormal part cannot be extracted from the event log and stability lacks depending on the nature of the adopted algorithm.

That is, since the event log of the abnormal part is a log of a rare pattern that does not usually occur, it is necessary to surely extract a specific pattern. However, if the extraction of the pattern is to be ensured, on the contrary, a log of a part having little or no relation with an abnormality is extracted.

The present disclosure has been made in view of the foregoing background, and an object thereof is to provide a log retrieval support device and a log retrieval support method capable of easily finding a part causing an abnormality of a system from an event log. [0010]

According to one aspect of the present disclosure for solving the above-described problems, provided is a log retrieval support device including: a processor and a memory; a rare series retrieval condition generation unit configured to specify a rare series that is an abnormal event group in a predetermined order in a log recording a plurality of events executed in a predetermined system and specified by a user and configured to generate a rare series retrieval condition that is a condition for regarding that there is a log having the same event group as each of the specified rare series for each rare series; a rare series retrieval unit configured to specify the number or ratio of logs having the same event group as each of the specified rare series among a plurality of logs recording a plurality of events executed in the predetermined system on the basis of each of the generated rare series retrieval conditions; and a rare series retrieval condition update unit configured to generate a new rare series retrieval condition obtained by partially relaxing the rare series retrieval condition in the case where the specified number or ratio is less than a predetermined number or a predetermined ratio and configured to generate a new rare series retrieval condition obtained by partially limiting the rare series retrieval condition in the case where the specified number or ratio is the predetermined number or more or the predetermined ratio or more.

In addition, according to another aspect of the present disclosure for solving the above-described problems, provided is a log retrieval support method implemented by an information processing device, comprising executing: rare series retrieval condition generation processing for specifying a rare series that is an abnormal event group in a predetermined order in a log recording a plurality of events executed in a predetermined system and specified by a user and for generating a rare series retrieval condition that is a condition for regarding that there is a log having the same event group as each of the specified rare series for each rare series; rare series retrieval processing for specifying the number or ratio of logs having the same event group as each of the specified rare series among a plurality of logs recording a plurality of events executed in the predetermined system on the basis of each of the generated rare series retrieval conditions; and rare series retrieval condition update processing for generating a new rare series retrieval condition obtained by partially relaxing the rare series retrieval condition in the case where the specified number or ratio is less than a predetermined number or a predetermined ratio and for generating a new rare series retrieval condition obtained by partially limiting the rare series retrieval condition in the case where the specified number or ratio is the predetermined number or more or the predetermined ratio or more.

According to the present disclosure, it is possible to easily find a part causing an abnormality of a system from an event log.

Problems, configurations, and effects other than those described above will be clarified by the description of the following embodiment.

### BRIEF DESCRIPTION OF THE DRAWINGS

FIG. 1 is a diagram for showing an example of a configuration of a log retrieval support system according to an embodiment;

FIG. 2 is a diagram for describing an example of a function provided in a log retrieval support device;

FIG. 3 is a diagram for showing an example of hardware provided in the log retrieval support device;

FIG. 4 is a flowchart for describing an example of log retrieval support processing;

FIG. 5 is a flowchart for describing an example of rare series retrieval condition update processing;

FIG. 6 is an example of a condition relaxation proposal screen;

FIG. 7 is a diagram for showing an example of an investigation target event log and a rare log when the type of rare series retrieval condition is “matching pattern”;

FIG. 8 is a diagram for showing an example of an investigation target event log and a rare log when the type of rare series retrieval condition is “extra pattern”;

FIG. 9 is a diagram for showing an example of an investigation target event log and a rare log when the rare series retrieval condition is “missing pattern”;

FIG. 10 is a diagram for showing an example of an investigation target event log and a rare log when the rare series retrieval condition is “unordered pattern”;

FIG. 11 is a diagram for showing an example of a condition limitation proposal screen;

FIG. 12 is a diagram for showing an example of a condition editing screen; and

FIG. 13 is a flowchart for describing an example of rare series retrieval condition update support processing.

### DETAILED DESCRIPTION OF EMBODIMENTS

Hereinafter, an embodiment of the present disclosure will be described using the drawings.

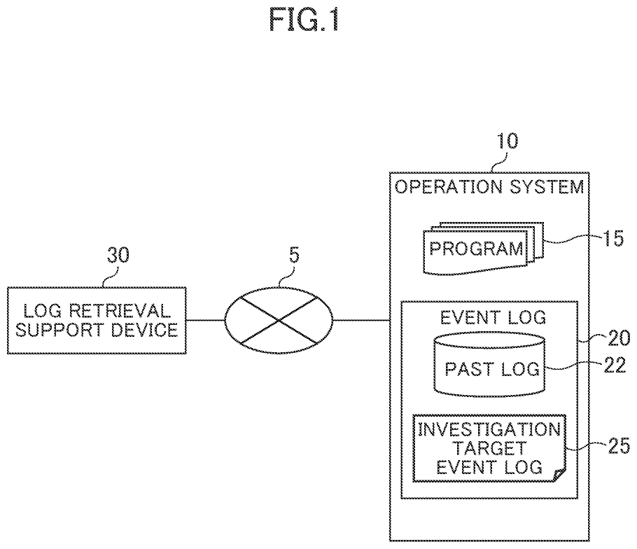

FIG. 1 is a diagram for showing an example of a configuration of a log retrieval support system 1 according to the embodiment. The log retrieval support system 1 includes an operation system 10 for outputting an event log 20 recording execution results obtained by executing various programs 15 (events) and a log retrieval support device 30 for acquiring the event log 20 and supporting the retrieval.

The operation system 10 and the log retrieval support device 30 are connected so as to be communicable with each other via, for example, a LAN (Local Area Network), a WAN (Wide Area Network), the Internet, or a wired (such as a leased line) or wireless communication network 5.

The operation system 10 is an information processing system used for a predetermined operation, and stores one or more programs 15. The operation system 10 executes or calls these programs 15 and outputs the execution history to the event log 20. In the embodiment, it is assumed that the event log 20 is information in which the name or identifier of the executed program 15 (event) is stored in the order of execution.

The event log 20 includes an investigation target event log 25 that is an event log 20 having a series of event parts (hereinafter, referred to as a rare series) indicating an abnormality (failure) of execution of the program 15 and a past log 22 (hereinafter, also referred to as a rare log) that is an event log 20 accumulated in the past.

The log retrieval support device 30 accepts an input of the investigation target event log 25 from a user (a system administrator or the like) and analyzes the investigation target event log 25 to specify the rare series in the investigation target event log 25. In addition, the log retrieval support device 30 generates a rare series retrieval condition that is information of a determination condition for regarding an event log 20 as including the same part as the rare series.

Then, the log retrieval support device 30 retrieves the past log 22 having the same part as the rare series of the investigation target event log 25 on the basis of the rare series retrieval condition, and corrects the rare series retrieval condition so as to be able to obtain a more appropriate retrieval result in accordance with the retrieval result. The log retrieval support device 30 generates, for example, a rare series retrieval condition that is satisfied as long as the past log is similar to the rare series even if it is not exactly the same as the rare series (the details thereof will be described later).

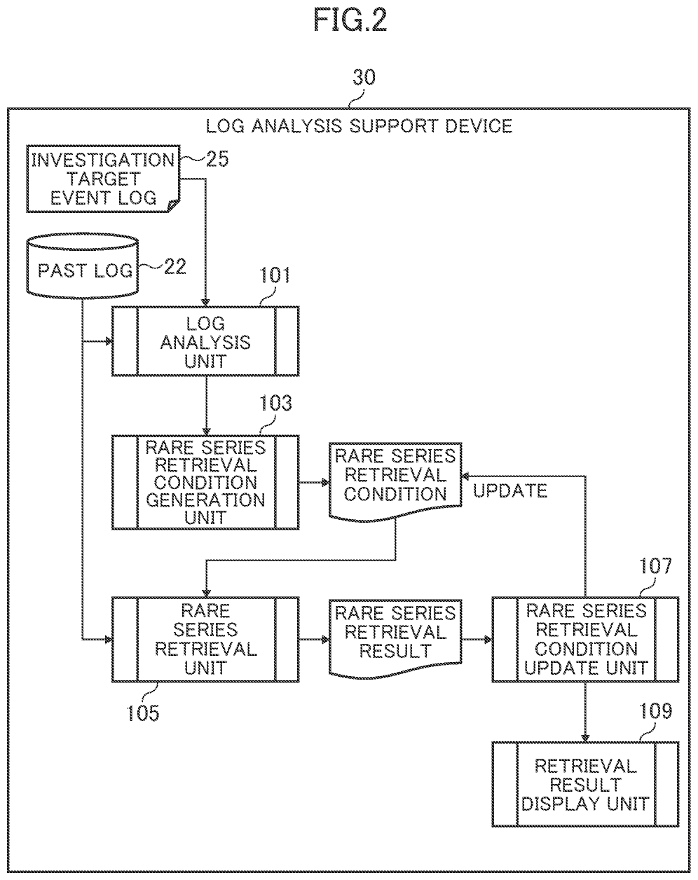

FIG. 2 is a diagram for describing an example of a function provided in the log retrieval support device 30. The log retrieval support device 30 includes respective functional units of a log analysis unit 101, a rare series retrieval condition generation unit 103, a rare series retrieval unit 105, a rare series retrieval condition update unit 107, and a retrieval result display unit 109.

The log analysis unit 101 calculates the appearance probability of each event appearing in each order in each event log 20.

The rare series retrieval condition generation unit 103 specifies a rare series that is an abnormal event group in a predetermined order in the investigation target event log 25, and generates a rare series retrieval condition that is a condition for regarding that there is a log having the same event group as the specified rare series for each rare series.

The rare series retrieval unit 105 specifies the number (the number of hits) or hit ratio of the past logs 22 having the same event group as each rare series specified by the rare series retrieval condition generation unit 103 among one or more past logs 22 on the basis of each rare series retrieval condition. In the embodiment, it is assumed that the rare series retrieval unit 105 specifies the number of hits.

In addition, in the case where the rare series retrieval unit 105 can specify a past log 22 having the same event group as the rare series among one or more past logs 22, the rare series retrieval condition corresponding to the rare series is specified.

In the case where the number of hits is less than a predetermined number, the rare series retrieval condition update unit 107 generates a new rare series retrieval condition obtained by partially relaxing the rare series retrieval condition, and in the case where the number of hits is equal to or larger than the predetermined number, the rare series retrieval condition update unit 107 generates a new rare series retrieval condition obtained by partially limiting the rare series retrieval condition. For example, in the case where the number of hits is less than the predetermined number, the rare series retrieval condition update unit 107 accepts an input of information of a condition for partially relaxing the rare series retrieval condition from the user, and in the case where the number of hits is equal to or larger than the predetermined number, the rare series retrieval condition update unit 107 accepts an input of information of a condition for partially limiting the rare series retrieval condition from the user.

As an example of a new rare series retrieval condition, for example, in the case where the number of hits is less than the predetermined number, the rare series retrieval condition update unit 107 generates a new rare series retrieval condition for permitting the presence or absence of a predetermined event among those related to the rare series retrieval condition, and in the case where the specified number is equal to or larger than the predetermined number, the rare series retrieval condition update unit 107 generates a new rare series retrieval condition in which a condition requiring the presence or absence of a new predetermined event for those related to the rare series retrieval condition is added.

In addition, for example, in the case where the number of hits is less than the predetermined number, the rare series retrieval condition update unit 107 generates a new rare series retrieval condition in which the order of execution of events related to the rare series retrieval condition is not considered, and in the case where the number of hits is equal to or larger than the predetermined number, the rare series retrieval condition update unit 107 generates a new rare series retrieval condition in which the order of events related to the rare series retrieval condition must be a predetermined order.

In the embodiment, at least the following four kinds of rare series retrieval conditions can be set by the rare series retrieval condition update unit 107 described above.

1. Matching Pattern: Only in the case where a certain past log 22 has the same part as a predetermined rare series (hereinafter, referred to as a matching pattern event) of the investigation target event log 25, it is determined that the past log 22 is the same as the rare series.

2. Extra Pattern: In addition to the case where a certain past log 22 has the same part as the rare series of the investigation target event log 25, even if a predetermined event (hereinafter, referred to as an extra pattern event) is excessively included in the part of the past log 22, it is determined that the past log 22 has the same part as the rare series.

3. Missing Pattern: In addition to the case where a certain past log 22 has the same part as the rare series of the investigation target event log 25, even in the case where the certain past log 22 is the same as a series part that lacks a part of an event (hereinafter, referred to as a missing pattern event) in the rare series of the investigation target event log 25, it is determined that the past log 22 has the same part as the rare series.

4. Unordered Pattern: In addition to the case where a certain past log 22 has the same part as the rare series of the investigation target event log 25, even in the case where the certain past log 22 is the same as a rare series (hereinafter, referred to as an unordered pattern event) in which the order of some or all events is made different in the rare series of the investigation target event log 25, it is determined that the past log 22 has the same part as the rare series.

It should be noted that the rare series retrieval conditions described above may be used for a certain rare series by combining plural conditions. For example, in the case where there is an event of a rare series of “A→B→C→D”, a new rare series retrieval condition in which “B” and “C” are unordered pattern events (4.) and “E” and “F” are extra pattern events (2.) may be generated on the basis of the rare series retrieval condition of the matching pattern (1.) as a rare series retrieval condition corresponding to the event (“A →([unordered pattern] B, C)→([extra pattern] E, F)→D”). This is realized, for example, using a condition editing screen 650 to be described later.

Further, the rare series retrieval condition update unit 107 may specify the order or type of each event in the rare series retrieval condition specified by the rare series retrieval unit 105 in the past, and may specify an event related to the limitation or relaxation of the rare series retrieval condition on the basis of the specified order or type.

Next, the retrieval result display unit 109 displays various kinds of information. For example, the retrieval result display unit 109 displays the number of hits or the hit ratio of the retrieval by the rare series retrieval condition update unit 107 and the contents of the rare series retrieval condition used for the retrieval. In addition, the retrieval result display unit 109 displays information of the past log 22 hit by the retrieval.

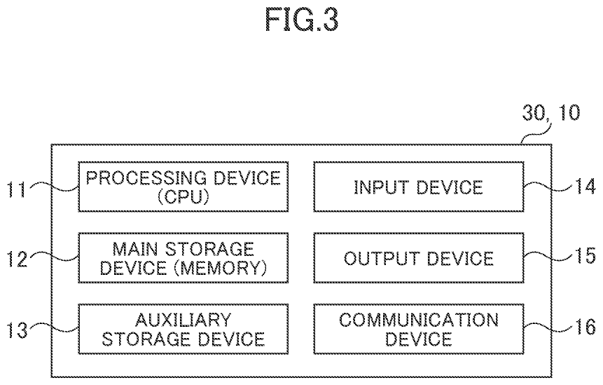

Next, FIG. 3 is a diagram for showing an example of hardware provided in the log retrieval support device 30. The log retrieval support device 30 includes a processing device 11 such as a CPU (Central Processing Unit), a main storage device 12 such as a RAM (Random Access Memory) or a ROM (Read Only Memory), an auxiliary storage device 13 such as an HDD (Hard Disk Drive) or an SSD (Solid State Drive), an input device 14 such as a keyboard, a mouse, or a touch panel, an output device 15 such as a monitor (display), and a communication device 16 for communicating with other devices. It should be noted that the operation system 10 includes a similar configuration.

Each of the functions of the log retrieval support device described above is realized by the processing device 11 executing a program stored in the storage device 12. These programs may be stored in, for example, a storage device such as a secondary storage device, a nonvolatile semiconductor memory, a hard disk drive, or an SSD, or a non-transitory data storage medium that is readable by each node such as an IC card, an SD card, or a DVD.

Next, processing performed by the log retrieval support device 30 will be described.

<Log Retrieval Support Processing>

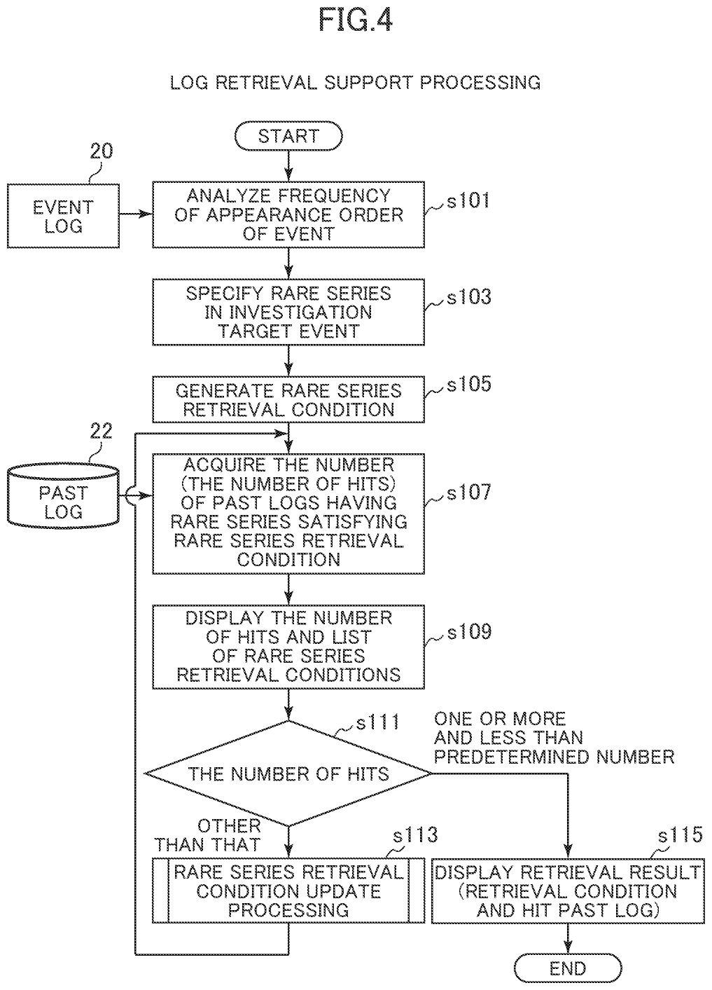

FIG. 4 is a flowchart for describing an example of log retrieval support processing for retrieving an abnormality in the investigation target event log 25 while updating the rare series retrieval condition. This processing is executed, for example, in the case where there is a predetermined input from the user to the log retrieval support device 30 or in the case where a new past log 22 is output to the operation system 10.

First, the log analysis unit 101 of the log retrieval support device 30 specifies, for each event log 20 (the investigation target event log 25 and the past log 22), the order of each event configuring the event logs, and calculates an event group configured using these events and the appearance frequency (for example, the appearance frequency for all the past logs 22 or all the event logs 20) of the order of each event in the event group (s101).

In addition, the rare series retrieval condition generation unit 103 specifies a rare series in the investigation target event log 25 designated by the user (s103).

For example, the rare series retrieval condition generation unit 103 accepts designation of one or more rare series from the user while displaying a screen displaying information of the investigation target event log 25 designated by the user.

Alternatively, for example, the rare series retrieval condition generation unit 103 may automatically specify one or more event groups within a predetermined appearance frequency range among the event groups specified in s101, display the specified event groups on the screen as rare series candidates, and allow the user to select.

The rare series retrieval condition generation unit 103 generates a rare series retrieval condition on the basis of the rare series specified in s103 (s105).

For example, the rare series retrieval condition generation unit 103 generates, as a rare series retrieval condition, information in which the investigation target event log 25, each rare series specified in s103, and information indicating “matching pattern” are associated with each other.

Thereafter, the rare series retrieval unit 105 reads the past log 22. For example, the rare series retrieval unit 105 displays a screen displaying a list of the past logs 22, accepts designation of the past log 22 from the user, and reads the designated past log 22 from the operation system 10. It should be noted that the rare series retrieval unit 105 may automatically read all the past logs 22.

Then, the rare series retrieval unit 105 determines, for each rare series retrieval condition generated in s105, whether or not each past log 22 satisfies the rare series retrieval condition, and calculates the number (the number of hits) of past logs 22 that satisfy the rare series retrieval condition (s107). That is, the rare series retrieval unit 105 determines, for each rare series retrieval condition, whether or not each past log 22 has a rare series that satisfies the rare series retrieval condition.

For example, only in the case where a certain past log 22 has the same part as the rare series related to a certain rare series retrieval condition, the rare series retrieval unit 105 determines that the past log 22 satisfies the rare series retrieval condition (in the case where the rare series retrieval condition is the matching pattern).

In addition, for example, in the case where the rare series retrieval condition is “extra pattern” in rare series retrieval condition update processing sill to be described later, not only when a certain past log 22 has the same part as the rare series related to the rare series retrieval condition but also when an extra pattern event is included in the relevant part of the past log 22, the rare series retrieval unit 105 determines that the past log 22 satisfies the rare series retrieval condition.

Then, the retrieval result display unit 109 displays the number of hits and a list of rare series retrieval conditions used for the retrieval on the screen (s109).

The rare series retrieval unit 105 confirms whether or not the number of hits calculated in s107 is one or more and less than a predetermined number (for example, 100) (s111).

In the case where the number of hits is one or more and less than a predetermined number (sill: one or more and less than the predetermined number), the rare series retrieval unit 105 executes processing of s115 to be described later. On the other hand, in the case where the number of hits is 0 or a predetermined number (for example, 100) or more (sill: other than that), the rare series retrieval unit 105 executes rare series retrieval condition update processing s113 (to be described later) for updating the rare series retrieval condition, and thereafter repeats the processing after s107.

In s115, the retrieval result display unit 109 displays the information of the rare series retrieval condition hit by the retrieval, together with the information of the past log 22 hit by the retrieval. In addition, the retrieval result display unit 109 stores the information of the rare series retrieval condition and the past log 22 as the optimum rare series retrieval condition. Thereafter, the log retrieval support processing is terminated.

### <Rare Series Retrieval Condition Update Processing>

FIG. 5 is a flowchart for describing an example of rare series retrieval condition update processing.

First, the rare series retrieval condition update unit 107 confirms whether or not the number of hits in s105 is 0 (s151).

In the case where the number of hits is 0 (s151: 0), the rare series retrieval condition update unit 107 executes processing of s153 to be described later, and in the case where the number of hits is the predetermined number (for example, 100) or more of s105 (s151: the predetermined number or more), the rare series retrieval condition update unit 107 executes processing of s157 to be described later.

In s153, the rare series retrieval condition update unit 107 relaxes at least any of the current rare series retrieval conditions.

For example, the rare series retrieval condition update unit 107 displays a condition relaxation proposal screen that is a screen for allowing the user to select relaxation of the rare series retrieval condition.

### Condition Relaxation Proposal Screen

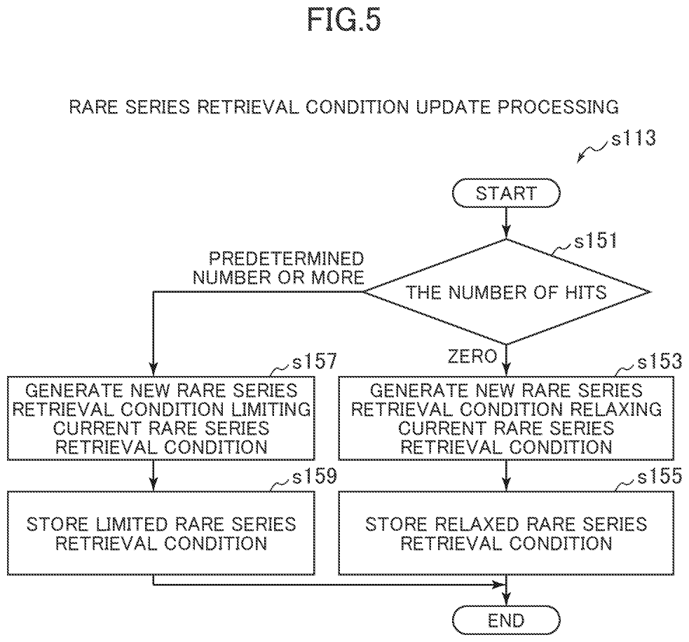

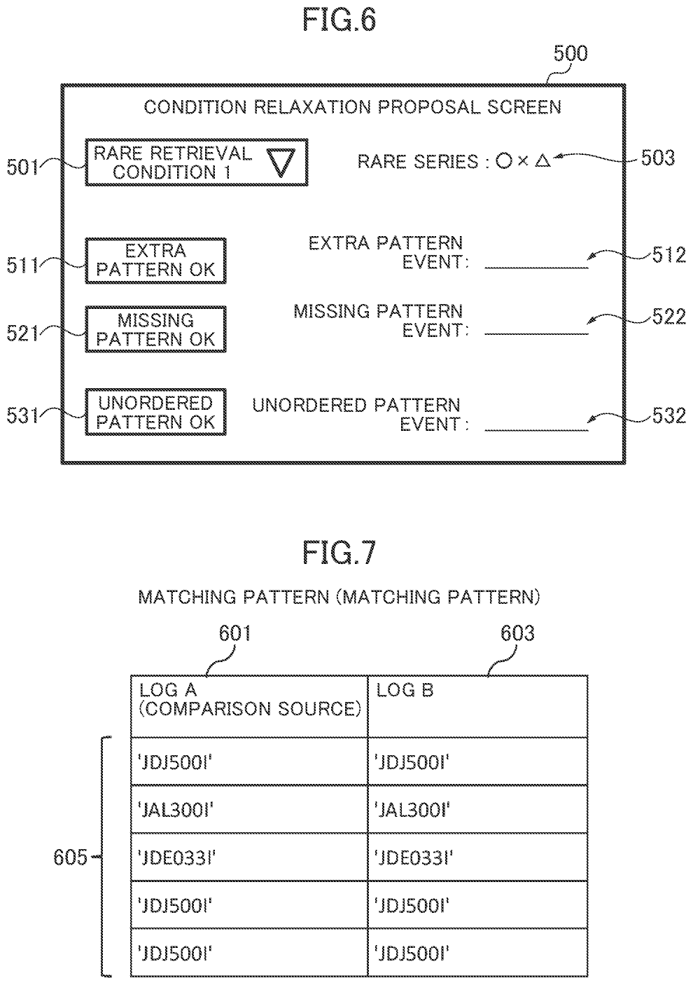

FIG. 6 is an example of a condition relaxation proposal screen. A condition relaxation proposal screen 500 includes: a retrieval condition selection section 501 that accepts a selection of a rare series retrieval condition from the user; a display section 503 of a rare series related to the rare series retrieval condition; an extra pattern selection section 511 that accepts from the user a selection of relaxation (“extra pattern”) of a condition in which the past log 22 is regarded to include the same part as the rare series even if an extra pattern event is included in the rare series retrieval condition indicated by the retrieval condition selection section 501; an extra pattern event selection section 512 that accepts a selection of the extra pattern event from the user; a missing pattern selection section 521 that accepts from the user a selection of relaxation (“missing pattern”) of a condition in which even if a missing pattern event does not exist in the event series related to the rare series retrieval condition indicated by the retrieval condition selection section 501, the past log 22 is regarded to include the same part as the rare series; a missing pattern event selection section 522 that accepts a selection of the missing pattern event from the user; an unordered pattern selection section 531 that accepts from the user a selection of relaxation (“unordered pattern”) of a condition in which the past log 22 is regarded to include the same part as the rare series even if the appearance order of events is different although the events are an event group (unordered pattern events) configured using the same events as the rare series related to the rare series retrieval condition indicated by the retrieval condition selection section 501; and an unordered pattern event selection section 532 that accepts a selection of the unordered pattern event from the user.

Next, as shown at s155 of FIG. 5, the rare series retrieval condition update unit 107 stores a new rare series retrieval condition selected or set by the condition relaxation proposal screen 500, and the rare series retrieval condition update processing is terminated.

Specifically, for example, the rare series retrieval condition update unit 107 associates the investigation target event log 25, the rare series, the event (the extra pattern event, the missing pattern event, or the unordered pattern event) associated with the rare series, and information (for example, the extra pattern, the missing pattern, the unordered pattern, or the matching pattern) indicating the type of rare series retrieval condition with each other, and stores the associated information as a rare series retrieval condition.

Here, a case where the past log 22 (rare log) is determined to satisfy the rare series retrieval condition will be described.

### <Case of “Matching Pattern”

FIG. 7 is a diagram for showing an example of an investigation target event log and a rare log when the type of rare series retrieval condition is “matching pattern”. As shown in the drawing, in the case where an investigation target event log 601 having a rare series 605 is compared with a rare log 603, the rare log 603 has exactly the same part as the rare series 605 in the investigation target event log 601. In this case, the log retrieval support device 30 determines that the rare log 603 satisfies the rare series retrieval condition in the investigation target event log 601.

### <Case of “Extra Pattern”

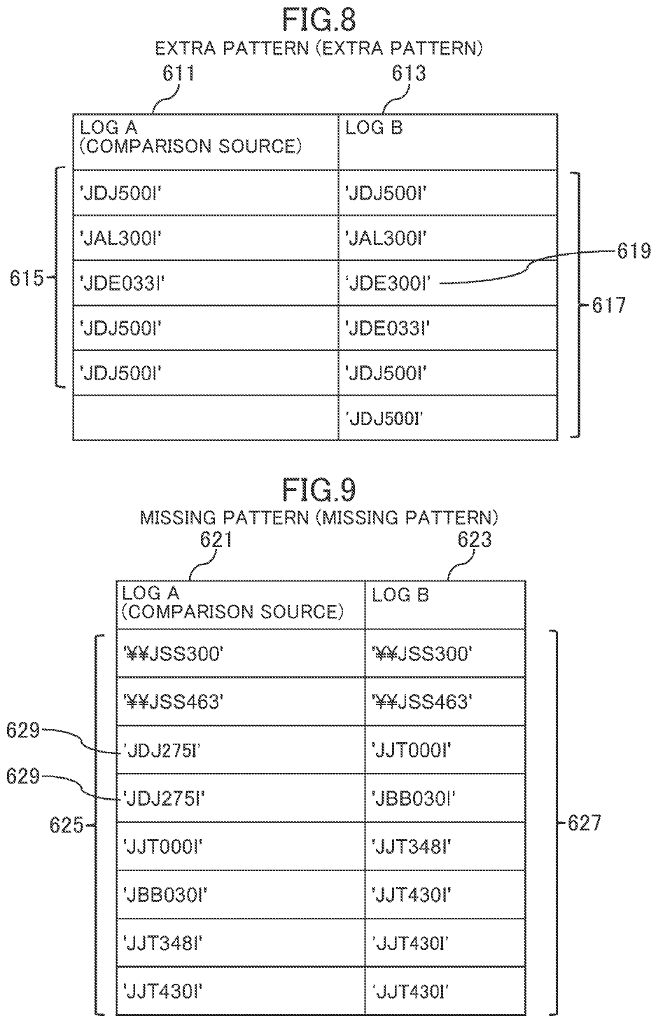

FIG. 8 is a diagram for showing an example of an investigation target event log and a rare log when the type of rare series retrieval condition is “extra pattern”. As shown in the drawing, in the case where an investigation target event log 611 having a rare series 615 is compared with a rare log 613, the rare log 613 has an event group 617 corresponding to the rare series 615 related to the investigation target event log 611, but the rare log 613 includes an extra pattern event 619 that is not present in the rare series 615 of the investigation target event log 611. Even in such a case, the log retrieval support device 30 regards the rare log 613 to have the same part as the rare series 615, and determines that the rare log 613 satisfies the rare series retrieval condition related to the investigation target event log 611.

### <Case of “Missing Pattern”

FIG. 9 is a diagram for showing an example of an investigation target event log and a rare log when the rare series retrieval condition is “missing pattern”. As shown in the drawing, in the case where an investigation target event log 621 having a rare series 625 is compared with a rare log 623, the rare log 623 has an event group 627 corresponding to the rare series 625 related to the investigation target event log 621, but the rare log 623 lacks an event 629 that is present in the rare series 625 of the investigation target event log 621. Even in such a case, the log retrieval support device 30 regards the rare log 623 to have the same part as the rare series 625, and determines that the rare log 623 satisfies the rare series retrieval condition related to the investigation target event log 621.

### <Case of “Unordered Pattern”

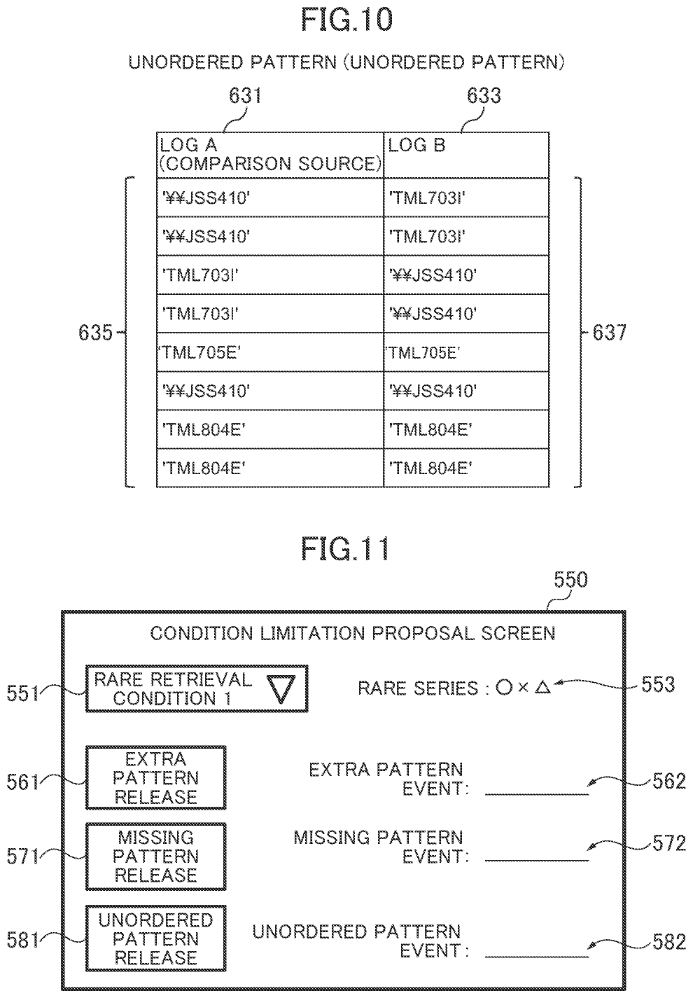

FIG. 10 is a diagram for showing an example of an investigation target event log and a rare log when the rare series retrieval condition is “unordered pattern”. As shown in the drawing, in the case where an investigation target event log 631 having a rare series 635 is compared with a rare log 633, the rare log 633 has an event group 637 corresponding to the rare series 635 related to the rare log 631, but the order of the events of the event group 637 in the rare log 633 and the order of the events of the rare series 635 related to the investigation target event log 631 are different from each other. Even in such a case, the log retrieval support device 30 regards the rare log 633 to have the same part as the rare series 635, and determines that the rare log 633 satisfies the rare series retrieval condition related to the investigation target event log 631.

Next, as shown in FIG. 5, in the case where the number of hits is the predetermined number or more (s151: the predetermined number or more), the rare series retrieval condition update unit 107 limits at least any of the current rare series retrieval conditions (s157).

For example, the rare series retrieval condition update unit 107 displays a condition limitation proposal screen that is a screen for allowing the user to select a limitation of the rare series retrieval condition.

### Condition Limitation Proposal Screen

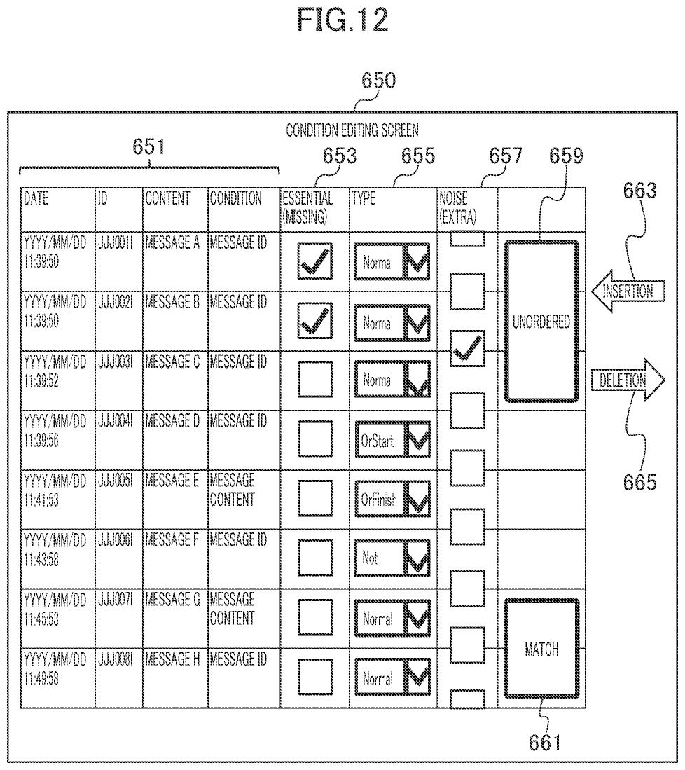

FIG. 11 is a diagram for showing an example of a condition limitation proposal screen. A condition limitation proposal screen 550 includes: a retrieval condition selection section 551 that accepts a selection of a rare series retrieval condition from the user; a display section 553 of a rare series related to the rare series retrieval condition; an extra pattern release section 561 that accepts a release of an extra pattern event from the user in the rare series retrieval condition indicated by the retrieval condition selection section 551; an extra pattern event selection section 562 that accepts a selection of an extra pattern event to be released from the user; a missing pattern release section 571 that accepts a release of a missing pattern event from the user; a missing pattern event selection section 572 that accepts a selection of the missing pattern event from the user; an unordered pattern release section 581 that accepts a release of an unordered pattern event from the user; and an unordered pattern event selection section 582 that accepts a selection of the unordered pattern event from the user.

Next, as shown at s159 of FIG. 5, the rare series retrieval condition update unit 107 stores a new rare series retrieval condition selected or set by the condition limitation proposal screen 550, and the rare series retrieval condition update processing is terminated.

Specifically, for example, the rare series retrieval condition update unit 107 associates the investigation target event log 25, the rare series, the event (the extra pattern event, the missing pattern event, or the unordered pattern event) associated with the rare series, and information (for example, the extra pattern, the missing pattern, the unordered pattern, or the matching pattern) indicating the type of rare series retrieval condition with each other, and stores the associated information as a rare series retrieval condition.

### Condition Editing Screen

As described above, there is a case where the rare series retrieval conditions are used in combination.

FIG. 12 is a diagram for showing an example of a condition editing screen 650 that is a screen for the user to create a rare series retrieval condition for a rare series by combining a plurality of rare series retrieval conditions. The condition editing screen 650 has: information 651 (the date and time, ID, contents, or other attribute information of each event) of each event configuring a rare series; an essential specification field 653 that accepts specification of whether or not the event is essential as a rare series (whether or not the event corresponds to a missing pattern event) from the user; a type specification field 655 that accepts specification of the type of the event from the user; a noise specification field 657 that accepts specification of the position of an event that becomes noise (becomes an extra pattern event) in the rare series from the user; an unordered pattern specification section 659 that accepts specification of an event group used as unordered pattern events from the user; a matching pattern specification section 661 that accepts specification of an event group used as matching pattern events from the user; a deletion specification section 663 that accepts specification of an event to be deleted from the rare series from the user; and an insertion specification section 665 that accepts specification of an event to be added to the rare series and the position thereof from the user.

In the type specification field 655, in the case where it is only necessary that any of events in a range exists, “OrStart” is set to the event at the start of the range and “OrFinish” is set to the event at the end of the range. In addition, in the type specification field 655, “Not” is set in the case where the event cannot exist. In addition, in the type specification field 655, “Normal” is set in the case where there is no type specification as described above.

The condition editing screen 650 allows the user to determine a configuration event of the rare series and to freely designate a combination of a plurality of rare series retrieval conditions to be applied to the rare series.

<Rare Series Retrieval Condition Update Support Processing>

Although the above-described rare series retrieval condition update unit 107 accepts an input of the update of the rare series retrieval condition (relaxation or limitation of the condition) from the user by using the condition relaxation proposal screen 500, the condition limitation proposal screen 550, and the condition editing screen 650, the rare series retrieval condition update unit 107 may update the rare series retrieval condition by automatically generating a rare series retrieval condition using the optimum rare series retrieval condition created by the retrieval of the investigation target event log 25 performed so far.

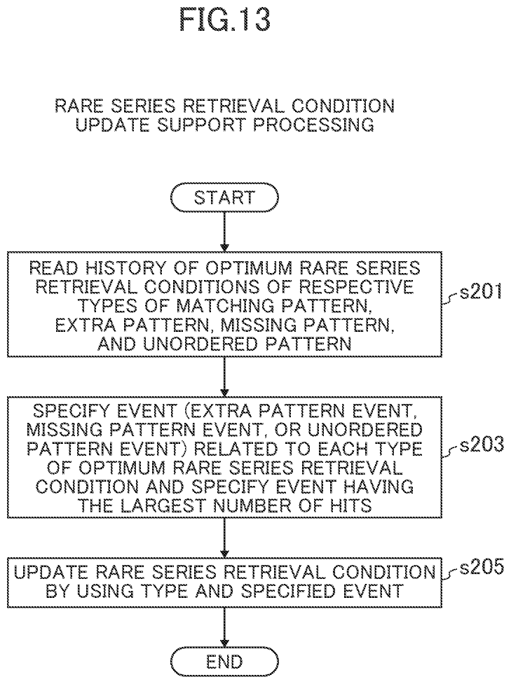

FIG. 13 is a flowchart for describing an example of rare series retrieval condition update support processing for updating a rare series retrieval condition using the optimum rare series retrieval condition.

First, the rare series retrieval condition update unit 107 reads the stored optimum rare series retrieval conditions of respective types related to the extra pattern, the missing pattern, and the unordered pattern (s201). Then, the rare series retrieval condition update unit 107 specifies the contents (configuration events, types, and orders) and the number of times of appearance of the event or the event group (the extra pattern events, the missing pattern events, or the unordered pattern events) associated with each type of optimum rare series retrieval condition to specify the series (the order and pattern) of the event or the event group that has appeared most frequently (s203).

The rare series retrieval condition update unit 107 updates the rare series retrieval condition by using the specified event or event group (S205). [0081]

For example, the rare series retrieval condition update unit 107 displays, as reference information, the event or the event group specified in s203 on the condition relaxation proposal screen 500 or the condition limitation proposal screen 550 together with the type of the corresponding rare series retrieval condition. In addition, for example, the rare series retrieval condition update unit 107 automatically sets the event or the event group specified in s203 to the corresponding rare series retrieval condition, so that a new rare series retrieval condition is set.

As an example, in the case where there is a rare series of “A→B→C” in the rare series retrieval condition of “extra pattern” and in the case where the condition is limited for an event of this rare series, the rare series retrieval condition update unit 107 refers to the optimum rare series retrieval condition and the corresponding past log 22, calculates the appearance frequency of an event that comes immediately after “A→B”, and specifies an event (for example, “D”) other than “C” having the highest appearance frequency, so that “A→B→D” is generated as a new rare series.

As described above, the log retrieval support device 30 of the embodiment specifies each rare series in the investigation target event log 25 of the operation system 10, generates each rare series retrieval condition that is a condition for regarding the presence of the past log 22 having the same event group as the specified rare series, and specifies the number of hits of the past log 22 determined to have the same event group as the rare series on the basis of each rare series retrieval condition. Then, in the case where the number of hits is a predetermined number or more, the log retrieval support device 30 partially limits and updates the rare series retrieval condition, and partially relaxes and updates the rare series retrieval condition in the case where the number of hits is less than the predetermined number.

Namely, since various events are executed in various patterns in the operation system 10, it is difficult to specify a specific event suggesting the presence of an abnormality or failure in these events. Accordingly, by relaxing or limiting the rare series retrieval condition in accordance with the rare series retrieval result for the past log 22, the log retrieval support device 30 of the embodiment can specify an event of the past log 22 corresponding to the abnormality or failure even if the user has no special expert knowledge.

As described above, according to the log retrieval support device 30 of the embodiment, a part causing an abnormality of the system can be easily found from the event log.

The present disclosure is not limited to the above- described embodiment, but includes various modified examples. The above-described embodiment has been described in detail for a better understanding of the present disclosure and is not necessarily limited to those having all the configurations described above.

For example, some of the functions included in the respective devices of the embodiment may be provided in other devices, or functions included in other devices may be provided in the same device.

In addition, in the embodiment, the log retrieval support device 30 acquires the event log 20 in the same operation system 10, but the event log may be acquired from a different operation system.

Further, in the embodiment, the log retrieval support device 30 sets the rare series retrieval condition as “matching pattern” when specifying a rare series first, but may set the rare series retrieval condition of “extra pattern”, “missing pattern”, or “unordered pattern” from the beginning.

In addition, in the embodiment, the event log 20 includes information of events and the execution order thereof, but may include other information (an execution date and time, time required for execution, event execution options, and the like) and the rare series retrieval condition may be applied to the information. In addition, the relative positions of events in the entire event log 20 may be calculated and used.

In addition, in the embodiment, the log retrieval support device 30 determines whether or not to generate a new rare series retrieval condition on the basis of the number of hits of the past log 22, but may determine whether or not to generate a new rare series retrieval condition on the basis of, for example, the ratio of the number of hits to the entire past log 22.

In addition, in the embodiment, the log retrieval support device 30 sets the optimum rare series retrieval condition in the case where the number of hits is one or more and less than a predetermined number, but may set the optimum rare series retrieval condition in other cases. For example, the log retrieval support device 30 may allow the user to select whether or not to set the optimum rare series retrieval condition every time retrieval is performed under the rare series retrieval condition.

In addition, the types of rare series retrieval conditions (the matching pattern, the extra pattern, the missing pattern, and the unordered pattern) described in the embodiment are merely examples, and other types of rare series retrieval conditions may be set. For example, the execution date and time, the time required for execution, the event execution options, and the relative positions of events may be used, or the configuration event itself of the rare series (not the extra pattern or the missing pattern) may be increased or decreased.

The above description of the specification clarifies at least the following. That is, the log retrieval support device 30 of the embodiment may include the retrieval result display unit for displaying at least the specified number or ratio or the contents of the generated rare series retrieval condition.

As described above, by displaying the number of hits of the retrieval by the rare series retrieval condition and the information of the rare series retrieval condition, the user can determine whether or not the rare series retrieval condition should be updated.

In addition, the log retrieval support device 30 of the embodiment may include the retrieval result display unit for displaying information of a log having the same event group as each of the specified rare series among the plurality of specified logs.

As described above, by displaying the information of the past log 22 hit by the retrieval, the user can use it as a reference in the case where it is determined whether or not the rare series retrieval condition should be updated.

In addition, in the case where the specified number or ratio is less than the predetermined number or the predetermined ratio, the rare series retrieval condition update unit of the log retrieval support device 30 of the embodiment may accept an input of a condition for partially relaxing the rare series retrieval condition from the user and generate the new rare series retrieval condition on the basis of the input condition, and in the case where the specified number or ratio is the predetermined number or more or the predetermined ratio or more, the rare series retrieval condition update unit may accept an input of a condition for partially limiting the rare series retrieval condition from the user and generate the new rare series retrieval condition on the basis of the input condition.

As described above, by allowing the user to input the relaxation or limitation of the rare series retrieval condition, an appropriate rare series retrieval condition can be found.

In addition, in the case where the specified number or ratio is less than the predetermined number or the predetermined ratio, the rare series retrieval condition update unit of the log retrieval support device 30 of the embodiment may generate the new rare series retrieval condition for permitting the presence or absence of a predetermined event among those related to the rare series retrieval condition, and in the case where the specified number or ratio is the predetermined number or more or the predetermined ratio or more, the rare series retrieval condition update unit may generate the new rare series retrieval condition in which a condition requiring the presence or absence of a new predetermined event for those related to the rare series retrieval condition is added.

As described above, by relaxing the condition (permitting the extra pattern event or the missing pattern event) or limiting the condition (prohibiting the extra pattern event or the missing pattern event) for the rare series retrieval condition related to “extra pattern” or “missing pattern”, even in the case where the operation system 10 executes a large number of events, it is possible to specify a specific event suggesting the presence of an abnormality or failure.

In addition, in the case where the specified number or ratio is less than the predetermined number or the predetermined ratio, the rare series retrieval condition update unit of the log retrieval support device 30 of the embodiment may generate the new rare series retrieval condition in which the order of execution of events related to the rare series retrieval condition is not considered, and in the case where the specified number or ratio is the predetermined number or more or the predetermined ratio or more, the rare series retrieval condition update unit may generate the new rare series retrieval condition in which the order of events related to the rare series retrieval condition must be a predetermined order.

As described above, by relaxing the condition (permitting the unordered pattern event) or limiting the condition (prohibiting the unordered pattern event) for the rare series retrieval condition related to “unordered pattern”, even in the case where the operation system 10 executes each event in a large number of patterns, it is possible to specify a specific event suggesting the presence of an abnormality or failure.

In addition, in the case where a log having the same event group as each of the specified rare series can be specified among the plurality of logs, the rare series retrieval unit of the log retrieval support device 30 of the embodiment may specify the rare series retrieval condition related to the rare series, and the rare series retrieval condition update unit may specify the order or type of each event related to the specified rare series retrieval condition and specify an event related to the limitation or relaxation of the rare series retrieval condition on the basis of the specified order or type.

As described above, by specifying the rare series retrieval condition used in the retrieval related to the investigation target event log 25 and by limiting or relaxing the rare series retrieval condition on the basis of the number and order of events (contents and history of the extra pattern event, the missing pattern event, the unordered pattern event, or the matching pattern) related to the specified rare series retrieval condition, it is possible to reasonably relax or limit the condition on the basis of the rare series retrieval condition optimized in the retrieval of the past log 22.

What is claimed is:

1. A log retrieval support device comprising:
a processor and a memory;
a rare series retrieval condition generation unit configured to specify a rare series that is an abnormal event group in a predetermined order in a log recording a plurality of events executed in a predetermined system and specified by a user and configured to generate, for each rare series, a rare series retrieval condition that is a condition for regarding that there is a log having the same event group as each of the specified rare series;
a rare series retrieval unit configured to specify the number or ratio of logs having the same event group as each of the specified rare series among a plurality of logs recording a plurality of events executed in the predetermined system, on the basis of each of the generated rare series retrieval conditions; and
a rare series retrieval condition update unit configured to generate a new rare series retrieval condition obtained by partially relaxing the rare series retrieval condition in the case where the specified number or ratio is less than a predetermined number or a predetermined ratio and configured to generate a new rare series retrieval condition obtained by partially limiting the rare series retrieval condition in the case where the specified number or ratio is the predetermined number or more or the predetermined ratio or more.

2. The log retrieval support device according to claim 1,
further comprising a retrieval result display unit configured to display at least the specified number or ratio or the contents of the generated rare series retrieval condition.

3. The log retrieval support device according to claim 1,
further comprising a retrieval result display unit configured to display information of a log having the same event group as each of the specified rare series among the plurality of specified logs.

4. The log retrieval support device according to claim 1,
wherein in the case where the specified number or ratio is less than the predetermined number or the predetermined ratio, the rare series retrieval condition update unit accepts an input of a condition for partially relaxing the rare series retrieval condition from the user and generates the new rare series retrieval condition on the basis of the input condition, and in the case where the specified number or ratio is the predetermined number or more or the predetermined ratio or more, the rare series retrieval condition update unit accepts an input of a condition for partially limiting the rare series retrieval condition from the user and generates the new rare series retrieval condition on the basis of the input condition.

5. The log retrieval support device according to claim 1,
wherein in the case where the specified number or ratio is less than the predetermined number or the predetermined ratio, the rare series retrieval condition update unit generates the new rare series retrieval condition for permitting the presence or absence of a predetermined event among those related to the rare series retrieval condition, and in the case where the specified number or ratio is the predetermined number or more or the predetermined ratio or more, the rare series retrieval condition update unit generates the new rare series retrieval condition in which a condition requiring the presence or absence of a new predetermined event for those related to the rare series retrieval condition is added.

6. The log retrieval support device according to claim 1,
wherein in the case where the specified number or ratio is less than the predetermined number or the predetermined ratio, the rare series retrieval condition update unit generates the new rare series retrieval condition in which the order of execution of events related to the rare series retrieval condition is not considered, and in the case where the specified number or ratio is the predetermined number or more or the predetermined ratio or more, the rare series retrieval condition update unit generates the new rare series retrieval condition in which the order of events related to the rare series retrieval condition must be a predetermined order.

7. The log retrieval support device according to claim 1,
wherein in the case where a log having the same event group as each of the specified rare series can be specified among the plurality of logs, the rare series retrieval unit specifies the rare series retrieval condition related to the rare series, and
wherein the rare series retrieval condition update unit specifies the order or type of each event related to the specified rare series retrieval condition and specifies an event related to the limitation or relaxation of the rare series retrieval condition on the basis of the specified order or type.

8. A log retrieval support method implemented by an information processing device, comprising executing:
rare series retrieval condition generation processing for specifying a rare series that is an abnormal event group in a predetermined order in a log recording a plurality of events executed in a predetermined system and specified by a user and for generating a rare series retrieval condition that is a condition for regarding that there is a log having the same event group as each of the specified rare series for each rare series;
rare series retrieval processing for specifying the number or ratio of logs having the same event group as each of the specified rare series among a plurality of logs recording a plurality of events executed in the predetermined system on the basis of each of the generated rare series retrieval conditions; and
rare series retrieval condition update processing for generating a new rare series retrieval condition obtained by partially relaxing the rare series retrieval condition in the case where the specified number or ratio is less than a predetermined number or a predetermined ratio and for generating a new rare series retrieval condition obtained by partially limiting the rare series retrieval condition in the case where the specified number or ratio is the predetermined number or more or the predetermined ratio or more.
